(19) United States
(12) Patent Application Publication
(10) Pub. No.: US 2008/0091782 A1
(43) Pub. Date: Apr. 17, 2008

(54) Method and system for delegating and managing tasks over instant messenger

(76) Inventor: Gabriel Jakobson, Las Vegas, NV (US)

Correspondence Address: Attn:Steven Rueben;PetNote LLC, 3862 Ruskin Street, Las Vegas, NV, 89147, US

(21) Appl. No.: 11/580,587

(22) Filed: Oct. 13, 2006

(51) Int. Cl. G06F 15/16

(52) U.S. Cl. 709/206

(57) ABSTRACT

A method and apparatus for allowing for the exchange of tasks, over an instant messenger (“IM”) infrastructure, are disclosed. An IM application, running on an electronic device, may provide functionality to create, assign, track, view, export, import and manage tasks. An IM application enhanced with functionality to handle tasks, may allow a user to exchange tasks with one or more other users during the course of a live session. The IM application may allow a user to edit tasks assigned to them, and create tasks for other users, while either offline or not in a live session with the other users. Tasks created or processed in an offline mode, may be stored and synchronized with one or more remote IM applications, when those remote IM applications engage in a live session with the local IM application. Tasks received by an IM application may be exported to and/or linked with tasks in information management applications, such as Microsoft Outlook®. A network of IM applications with functionality to handle tasks may become a medium over which disparate information management applications may exchange tasks.

### FIELD OF INVENTION

The present invention relates to the use of instant messaging over electronic devices. More particularly, the present invention relates to enhancing instant messenger services by adding and incorporating a framework for a peer-to-peer exchange of tasks among instant messenger users.

### BACKGROUND OF THE INVENTION

Instant messaging (or “IM”) has become a popular way for hundreds of millions of people world-wide to exchange messages in real time. Examples of popular instant messenger services include Qnext®, Windows Live Messenger®, AOL Instant Messenger®, Yahoo! Messenger®, Skype®, Google Talk®, .NET Messenger Service®, Jabber®, QQ®, Excite/Pal iChat® and ICQ®. Instant messaging applications use various protocols to allow users, using client-sided applications, to connect to servers which broker the messaging communications between users. Instant messenger users can add other users—often people with whom they converse frequently—to a contact list. Most instant messaging applications allow users to “see” which of their friends in the contact list are online, as well as see those users' status (such as “away” or “busy”). Instant messaging applications often offer an “offline” feature, which allows users to send messages to users who are not actively on line. (i.e. are not currently signed in to the instant messaging services and are not in a “chat session”). Such messages are often queued up on the serves brokering the instand messaging transactions. Once a user, who is the intended recepient of a message, logs in to the messaging service, their client messaging software may check for any offline messages and display any messages sent to them while they were offline. Many instant messaging applications offer a history feature, which allows a user to review a recording of their chat conversation with another user. While instant messaging applications may generally allow users to exchange various forms of content, such as text, graphics, audio and video, they lack the capability for assigning and tracking tasks among users.

In recognition of the need to help people manage their tasks, various productivity and task-scheduling applications and services have evolved. One breed of such solutions is numerous personalized task-tracking applications (e.g. Microsoft Outlook®, BlackBerry® or Palm® desktop applications, TaskSolutions CheckList™, Lotus Notes®, etc) Such applications allow a user to organize and track their own tasks. In some cases, these applications interface with an external system-of-record, such as Microsoft Exchange®. These applications may also interface with PDAs (personal digital assistants) or smart phones, creating a continuum between a user's hand-held device and a back office system of record. In a typical fashion, a user may create a task in an application such as Microsoft Outlook®, interfacing with a back-office server such as Microsoft Exchange®. When the user synchronizes their PDA with the Exchange® server, that task shows on their PDA or smart phone. Once they have marked that task as “complete” on their device, and synchronized it back with the Exchange® server, the master record of that task is marked as complete. Any other application or device interfacing with the user's account on that Exchange® server will display the correct status of that task. Various features in these tools may allow user to define a task, send it to another user who, in turn, may accept or reject it; and, receive notification when the recipient has executed the task. This may work as long as both sender and recipient are on the same platform, in the same physical or virtual environment. Platform compatibility issues, portability issues, corporate security policies and lack of a common protocol are among the factors inhibiting an effective way for a heterogeneous group of users to delegate and track tasks.

While IM products have bridged many of the communication challenges among heterogeneous users with incompatible systems of record, they lack a framework for delegating and tracking tasks. User A may type a task, in the form of a text message over IM, to User B. At present, User B does not have a way of importing that text message into their system of record, such as MS Outlook®, as an official task (a task typically has numerous attributes in addition to the text of the task, such as the name of person issuing the task, the task's priority, a completion deadline, etc.) Upon typing a message with a task to User B, User A has no way of tracking the progress User B is making in fulfilling the task.

### DESCRIPTION OF THE DRAWINGS

For a more complete understanding of the present invention and further advantages thereof, references are now made to the following Detailed Description, taken in conjunction with the drawings, in which:

FIG. 1. is a generalized block diagram illustrating an instant messenger system with enhancement modules to handle tasks, according to one embodiment.

FIG. 2. is a generalized block diagram illustrating one embodiment of the present invention where various API calls are used for communication between a tasks plug-in and an instant messenger application.

FIG. 3. is a generalized block diagram illustrating a tasks module incorporated into an IM framework, according to one embodiment of a “conversation model” of the present invention.

FIG. 4. is a generalized block diagram illustrating a tasks-handling infrastructure within an IM framework, according to one embodiment of a “content tab model” of the present invention.

FIGS. 5A & 5B are generalized block diagrams illustrating the interaction of a “live conversation mode” and a “content tab mode” tasks modules within an IM framework, according to one embodiment of the present invention.

FIG. 6 is a generalized block diagrams illustrating the interaction between two tasks modules within an IM framework, according to one embodiment of the present invention.

FIG. 7 is a generalized flow diagram illustrating the operation of a tasks module in “conversation mode”, according to one embodiment of the present invention.

FIG. 8 illustrates a communication flow between two tasks modules in one embodiment of the present invention.

FIG. 9 is a generalized block diagram illustrating the utilization of an IM application and infrastructure to facilitate an exchange of tasks among information management applications, according to one embodiment of the present invention.

FIGS. 10A/10B/10C/10D are generalized flow diagrams illustrating the operation 1000 of a tasks module in a “Content Tab mode”, according to one embodiment of the present invention.

FIG. 11 is a generalized block diagram illustrating displaying a user alert in response to a received task, in one embodiment of the present invention.

FIGS. 12A and 12B is a generalized block diagrams illustrating the interaction between a tasks module, a second tasks-module-window, and a host IM application, according to one embodiment of the present invention.

### SUMMARY OF THE INVENTION

The present invention provides a method and system for creating, delegating, exchanging and managing tasks over an instant messenger (or “IM”) infrastructure. Modules for handling tasks may be added to applications capable of IM over a network. Task-enabling-modules may be added to IM applications as plug-ins. Task plug-ins may respond to events generated by the host IM application, and use methods exposed by the host IM application for communicating with remote task-modules and performing read/write operations from and to storage. In another possible embodiment a tasks-enabling module may be an integral part of an IM application. In alternate embodiments, information management applications capable of managing tasks, such as Microsoft Outlook®, may interface with tasks-enabled IM applications to leverage the IM infrastructure for exchanging tasks among users on disparate information management applications.

Tasks enabled-modules may operate in two modes: “live conversation mode” and “tab dialog mode”. A live conversation mode implies that two or more users are engaged in a live IM session (such as a chat session) and tasks are exchanged among them in real time. All tasks displayed and handled in live conversation mode may be in context of the users engaged in the live session. In a tab dialog mode, the user of the IM application may be able to access tasks while the IM application is offline. The user of the IM application may be able to access and edit tasks created by, and for, users other than any users who may be engaged in a live conversation during that time. Tasks created and edited in an offline/tab dialog mode, and in an online/conversation mode, may be accessible in both modes. The user may control various preferences, such as the type of user alert that may indicate the arrival of a task from a remote user.

### DETAILED DESCRIPTION

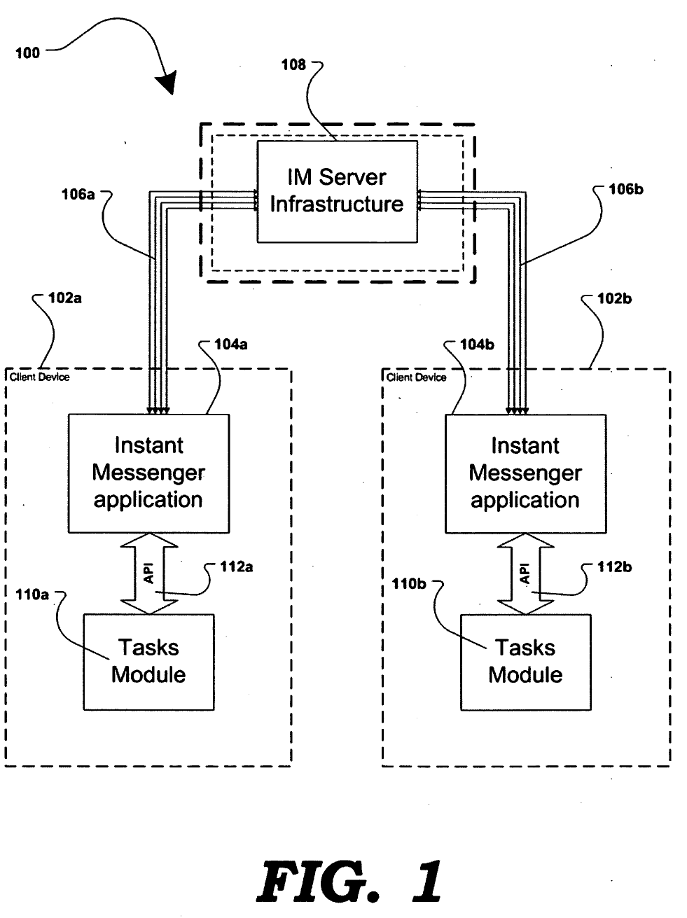

FIG. 1. is a generalized block diagram illustrating an instant messenger system 100 with enhancement modules to handle tasks, according to one embodiment. Client devices 102a and 102b (e.g. personal computers, laptops, personal digital assistants, cellular phones, etc.) may allow the users of these devices to communicate with one another over a network 106a and 106b (e.g. the internet, an intranet, wireless network, peer-to-peer network, etc). Client device 102a may employee an application 104a capable of instant messaging. Client device 102b may also employee an application 104b capable of instant messaging. Instant messages (e.g. chat text) between client instant messenger applications 104a and 104b may be transmitted over a network 106a/106b, and relayed by an instant messenger server infrastructure 108. The architecture described above is substantially similar to the operation of most popular applications and services supporting instant messaging, such as Qnext®, Windows Live Messenger®, AOL Instant Messenger®, Yahoo! Messenger®, Skype®, Google Talk®, .NET Messenger Service®, Jabber®, QQ®, Excite/Pal iChat®, Trillian® and ICQ®.

Client Instant messaging application 104a may support a tasks module 110a (the tasks module may be a plug-in, a plug-in being a computer program which registers itself with, and provides functionality to a host computer application) which may use application programming interface (API) 112a to communicate with host IM application 104a. Similarly, client instant messaging application 104b may support a tasks module 110b which may use application programming interface (API) 112b to communicate with application 104b. Messages exchanged between client application 104a and client applications 104b may be generally available to tasks module 110a via API 112a, and to tasks module 110b via API 112b. Tasks module 110a and tasks module 110b may exchange messages with each other by virtue of being a part of the messenger applications 104a and 104b communication channel and infrastructure. While messenger applications 104a and 104b may generally exchange user chat-related messages, tasks modules 110a and 110b may exchange text pertaining to task assignment.

A user using instant messenger application 104a on client device 102a may use the interface of tasks module 110a to assign tasks to the user of device 102b. The user of device 102b may see the tasks in tasks module 110b of client instant messenger application 104b. In the currently preferred embodiment of the present invention, tasks module 110a may contain a list of tasks assigned through tasks module 110b, in a manner analogous to instant messenger application 104a displaying text messages typed in instant messenger application 104b. Similarly, tasks module 110b may contain a list of tasks assigned through tasks module 110a.

User A may use instant messenger (“IM”) application 104a to type a text message to User B of IM application 104b. User A may use the user interface of tasks module 110a to assign a task to User B. The task message received by module 110a may be relayed to IM application 104a via API 112a. Combined data, comprising any text User A typed on IM application 104a, coupled with the task User A entered into tasks module 110a, may be relayed to IM application 104b. The combined data may then be split by IM application 104b into the text message—which may be shown in IM application 104b—and the task which may be shown in module 112b.

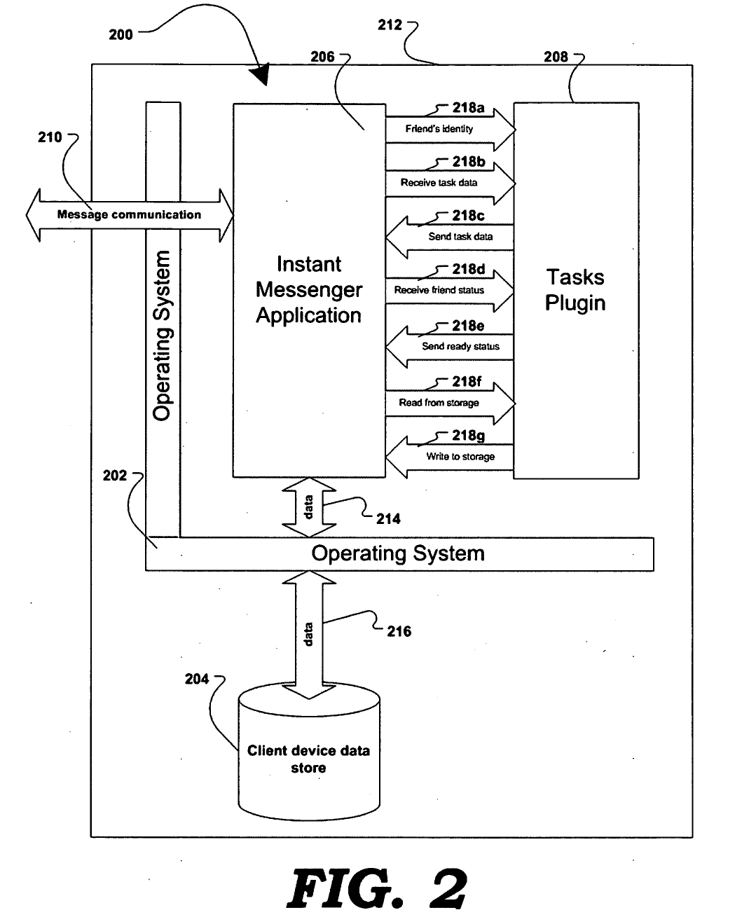

FIG. 2. is a generalized block diagram illustrating one embodiment of the present invention where various API calls are used for communication between a tasks modules and an instant messenger application. Client-sided applications which provide instant messaging (“IM”) functionality, typically support plug-ins. In the present example, the task modules are plug-ins. Plug-ins are small programs which inherit a subset of the framework of the host application—in this case the IM client—and may enhance the functionality of their host application. In the presently preferred embodiment, system 200 operates on a client device 212, and may include an IM application 206 which enables the user of the client device 212 to communicate with other IM applications on other client devices, over a network 210 available to the client device 212. IM application 206 may interface with the operating system 202 on the client device 212 to accomplish tasks such as communication, through channel 210, and storage of data on a storage device 204 accessible to the client device 212. Tasks plug-in 208 may register itself with IM application 206 as a plug-in. Communication between tasks plug-in 208 and IM application 206 may be facilitated by application programming interface (“API”) 218a-218g. According to one embodiment of the present invention, tasks plug-in 208 may use API calls 218a-218g to its host IM application 206, to communicate with remote task-enabled systems; and, with the storage device 204 of the client device 212. In alternate embodiments the IM API 218a-218g may include more or fewer function calls than Shown in FIG. 2.

When the user of IM application 206 makes a connection with a remote user, for example by initiating a chat session, a session between IM application 206 and a remote IM application, may be created and transacted over communication channel 210. Tasks plug-in 208 may use API call 218a to receive the “friend's name”, or other identifying information, of the remote user with whom IM application 206 has established a session. Additional information about the identity of the remote user chatting, or other attributes of the remote user, may be obtained in a similar fashion.

Tasks plug-in 208 may receive tasks assigned to a user associated with the tasks plug-in 208 by the remote user (using a tasks module or other task program), for example by executing API command 218b. Once remote tasks are received, tasks plug-in 208 may display the list of tasks to the user.

Tasks plug-in 208 may send a list of tasks composed by the local user, to a remote user, using API command 218c.

API function call 218d may enable tasks plug-in 208 to obtain the status of the tasks plug-in of the remote user, and API function call 218e may enable tasks plug-in 208 to send its own ready status to the remote device.

API function call 218g may allow tasks plug-in 208 to write 216 a list of tasks to a storage device 204 accessible to client device 212—for example, to store tasks permanently when the user closes tasks plug-in 208. API command 218f may allow tasks plug-in 208 to read 216 a list of tasks from storage 204 accessible to user device 212—for example when the user re-invokes plug-in 208 and plug-in 208 needs to read its stored list of tasks and display them to the user.

As stated above, in the present embodiment tasks plug-in 208 is a plug-in into IM application 206. Thus, communications between tasks plug-in 208 and the client's machine 212—as well as the remote machine hosting the remote tasks plug-in-may be brokered by IM application 206. IM application 206 may invoke events in plug-in 208, pass data to it, receive information from it and read and write to a local storage device 204, on the behalf of tasks plug-in 208. For example, tasks plug-in 208 may register an even-notification function with IM application 206, requesting to be notified when the remote tasks plug-in becomes available. Upon receipt of a “ready status” message from the remote tasks plug-in, over communication channel 210, IM Application 206 may notify plug-in 208 of the new status over API call 218d.

Alternate embodiments of Instant Messenger Application 206 may incorporate the functionality of Tasks Plug-In 208, in part or in whole, into IM application 206. The code-base allowing tasks plug-in 208 to perform its functionality may be made a part of IM application's 206 code-base, such that IM application 206 may provide the task management functionality described herein, natively, without the need for an external tasks plug-in.

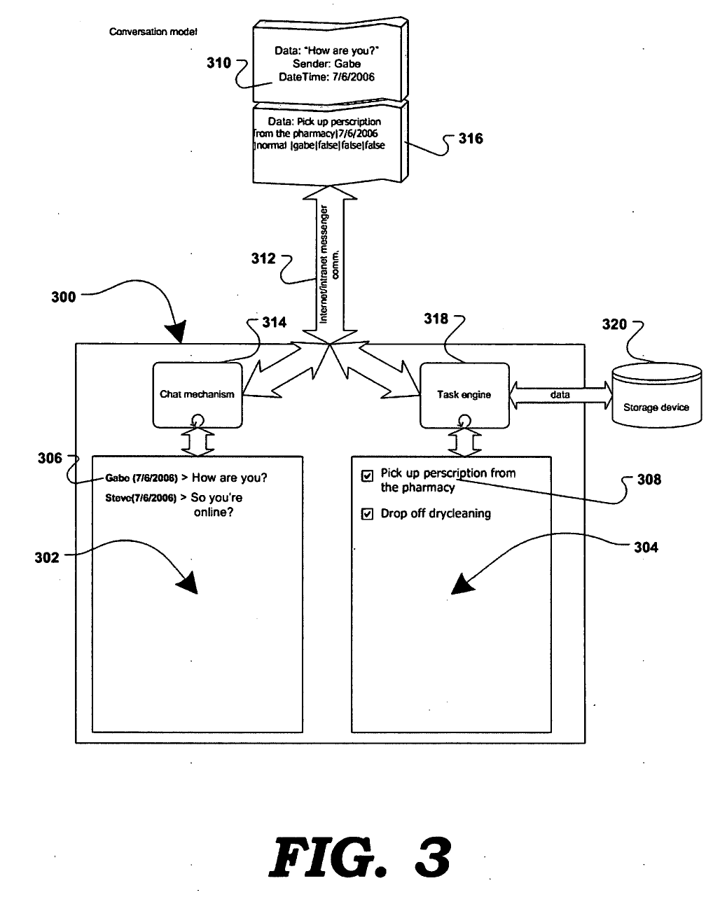

FIG. 3. is a generalized block diagram illustrating a tasks module incorporated into an IM framework, according to one embodiment of a “conversation model” of the present invention. Unless stated otherwise, “Conversation Model” refers to fact that a user of IM application 300 is using the tasks module 304 as part of a live session with another user.

A session may include data 310 & 316 exchanged between IM application 300 and a remote IM application. Conventional IM applications use data 310 containing chat text, for example “How are you?”, which is received by an IM application 300 on a client's machine, from a communications network 312 (such as the Internet or any other type of communications network capable of supporting a chat session). Data 310 may be processed by a chat engine 314 and presented to the user of the IM application 300 in a chat display window 302 as chat text 306. Data pertaining to tasks 316 may be transmitted similarly over the same communications network 312 as part of the same chat session, and may be received by IM application 300.

Tasks data 316 received by IM application 300 may be processed by a task engine 318 and received by tasks module 304. Tasks module 304 may process the task data 316 and display it for the user as itemized tasks 308. Task data 316 may be recorded on, and/or retrieved from, a storage device 320 accessible to IM application 300. A user may update, delete, or add to tasks 308 using IM application 300 or another application (for example, a user checking a checkmark to mark a task as complete). Task update information may be processed 318 and transmitted over network 312, as data packet 316, to the remote IM application. In the presently preferred embodiment the task update information is transmitted in live session with IM application 300. In this manner the task update information may be transmitted as part of the Conversation Model to other users who are assigned tasks, have assigned tasks to the user updating the task information, or to users designated to receive task update information (for example, users who are merely made aware that one user has assigned a task to another user).

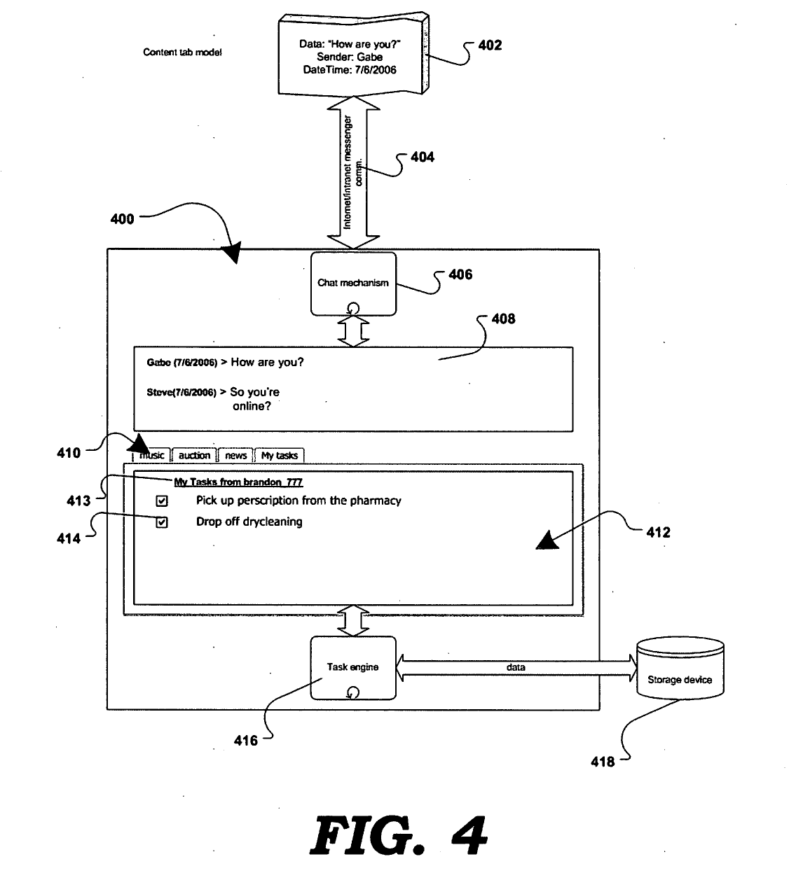

In the currently-preferred embodiment, upon establishing a live session and receiving a “ready” status form the remote tasks plug-in, the local tasks plug-in 304 may send all tasks stored in storage 320, and pertaining to the remote user, to the remote plug-in. This may allow for all tasks modified while in offline mode to be synchronized to the remote user upon the establishment of a live session. As discussed below in connection with FIG. 4, alternate embodiments may have the tasks-module operate in an offline/“tab mode”—allowing the user to make modifications to tasks while not in live session.

In alternate embodiments, data pertaining to chat 310 and data pertaining to tasks 316, exchanged among IM applications with tasks-enabling modules, may co-exist or be arranged or combined with other information in various fashions. Additionally, task and chat data may be sent in increments, alone or in various combinations.

FIG. 4. is a generalized block diagram illustrating a tasks-handling infrastructure within an IM framework, according to one embodiment of a “Content Tab model” of the present invention. “Content Tab” refers to the tasks module 412 being accessible to the user of IM application 400 outside, or independently of, any live chat sessions. IM applications generally support content tabs 410 (such as downloadable music content, news updates, stock quotes, etc.) which allow the user to access online and offline content on IM application 400 independently of any sessions.

The user of IM application 400 may be engaged in a live chat session with one or more users of other IM applications, over network 404. In a conventional IM application, chat text 402 may be received by the IM application 400, processed by a chat mechanism 406 and displayed in the form of chat text 408. The preferred embodiment of the tasks module tab 412 may be accessible to the user of IM application 400 independently of IM application's 400 online/offline state or the presence or absence of any live chat sessions between IM application 400 and any other IM applications. In one preferred embodiment, tasks module tab 412 may display a list of stored tasks 414. The user may be able to select the criteria for showing specific tasks (for example choosing all tasks from user “Brandon_{—}777” 413, or other criteria such as tasks not completed, oldest tasks, tasks with the nearest due date, etc.). Tasks module tab 412 may then obtain a list of tasks 414 pertaining to the chosen criteria. The obtained tasks data may be processed 416 and displayed 414 on a task window included on the task module tab 412.

The user may update or modify the tasks displayed 414 (for example, change the status of existing tasks to indicate their state of completion, change the task, or add additional people to view or participate in the task) and store the updated tasks. At a future time, the updated tasks may be uploaded (from their place of storage 418, which may be on the client device or may be on another computer or electronic device) and synchronized to the original users, on remote IM applications. In the currently-preferred embodiment, the synchronization takes place upon the establishment of a connection to the chat service (which may or may not be part of establishing a chat session).

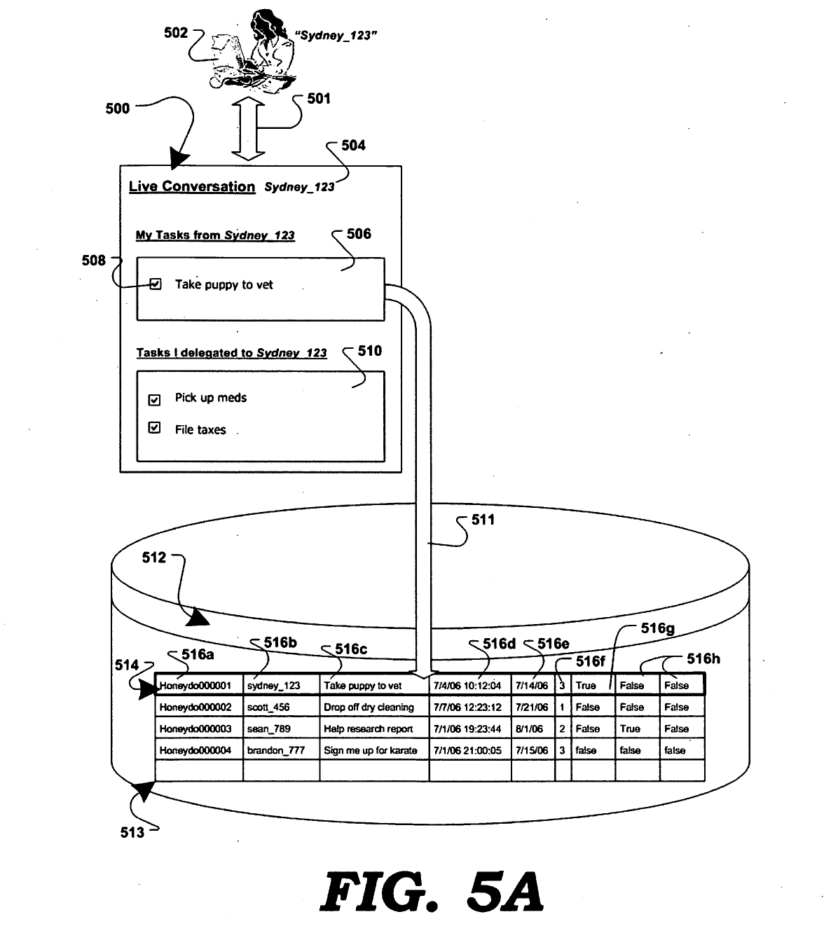

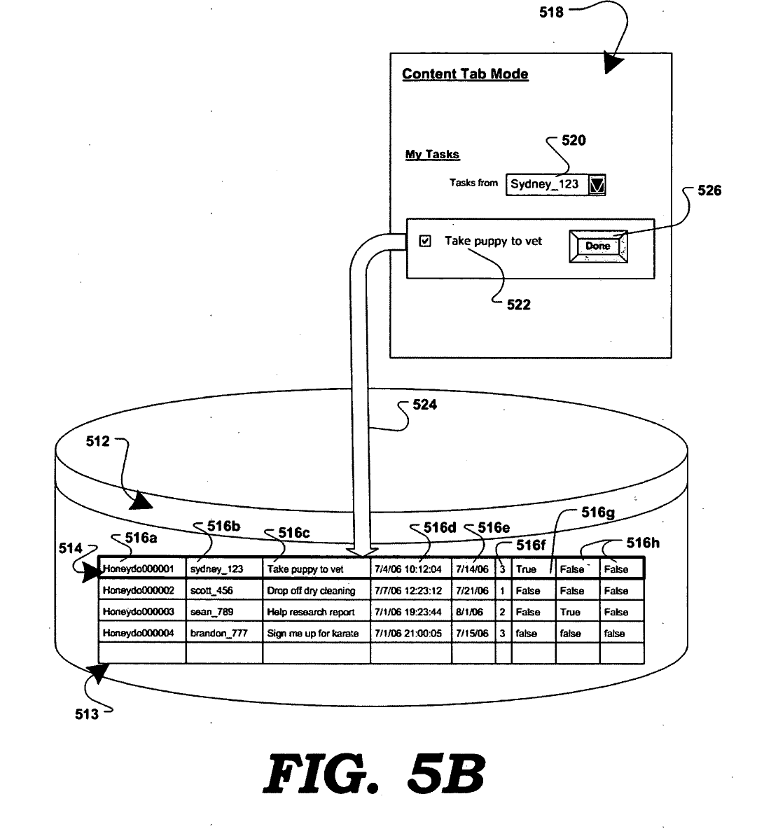

FIGS. 5A & 5B are generalized block diagrams illustrating the interaction of a “live conversation mode” and a “content tab mode” tasks modules within an IM framework, according to one embodiment of the present invention. Referring to FIG. 5A, the user of the tasks module 500 of an IM application may be in a chat session with a remote user “Sydney_{—}123” 502 over communications network 501. The user of “live conversation” tasks module 500 may see two windows: A “My Tasks” window 506 displaying the tasks 508 the remote user 502 had delegated to the local user (the terms local user and remote user are used for discussion purposes to identify two or more users who have communicated task information, and do not require users to be physically separated); and, a “Tasks I Delegated” window 510 listing the tasks the local user had delegated to one or more remote users 502. A label 504 denoting the name of the remote user associated with the displayed tasks may also be displayed in the “Tasks I Delegated” window 510. The “Tasks I Delegated” window 510 may display all delegated tasks, or may filter delegated tasks according to one or more criteria, such as the user the tasks have been delegated to, the due date and/or due time of the tasks, the delegation date and/or delegation time of the tasks, the status of the task, etc. As shown in FIG. 5A, the tasks shown in the “Tasks I Delegated” window 510 are filtered to show tasks delegated to a given user. In the presently preferred embodiment, task records 513 of the tasks 508 assigned to the local user, along with any properties of these tasks are stored locally to allow access to the tasks 508 without the need to establish communication with the IM service. However, alternate embodiments may store task records 508 on a remove computer, accessible through the chat service or accessible without need to establish a connection to the chat service.

In a currently preferred embodiment, task records 513 may be stored using a file system with unique file (or record) names. In other embodiments, task records 513 may be stored in a database with one or more tables storing task information. A given task record 514 may have a unique name such as “Honeydo000001” 516a, which may contain one or more characters differentiating it from other records (in this example, other records may be named “Honeydo000002”, “Honeydo000003” . . . ) so that the task record 514 may be retrieved by a reference to its unique name. The task record 514 of task 508 may have additional attributes stored. For example, some attributes may include: sender's name 516b, text of the task 516c, date task received 516d, date task is due 516e, task priority 516f, task completed flag 516g, any other flags 516e and 516f, etc. Changes a user makes to a task 508 assigned to them, such as marking it as complete, may be written 511 to task record 514.

In the “Content Tab Mode” of the embodiment illustrated in FIG. 5B, the user may access a task 522 displayed in tasks module 518. The user may be able to select a category of tasks (for example, based on the user who had assigned the tasks 520) and retrieve 524 the tasks from a task record 514. Drop-down box 520 may be populated by all unique user names in the task records (or may include all unique user names in the contacts list of the IM 500, or may include only those unique user names which have a current task, etc.), such that the local user may choose to see tasks assigned by any particular remote user. The local user may change the attributes of a task, such as marking it as complete (for example, by pressing the “done” button 526.) A change in one or more attributes of a task 522 may be recorded in that task's record 514. (e.g. the completed flag 5169 may be changed from a “false” to a “true” to indicate completion.) The appearance or content of the tasks module 518 in “content tab mode” may not be effected by the presence or absence of one or more live sessions, or by the client machine's online/offline state. As both the “content tab” and “live conversation” modes of the tasks modules 500 and 518 interact with the same data store 512. In the presently preferred embodiment, tasks attributes that may be changed by the user in one mode, may be reflected in the other mode. For example, once the user has pressed the “done” 526 button and marked task 522 as complete, the data may be recorded 514 and the “complete” status of the task may be synchronized to a remote user at, approximately, that time or at a later time.

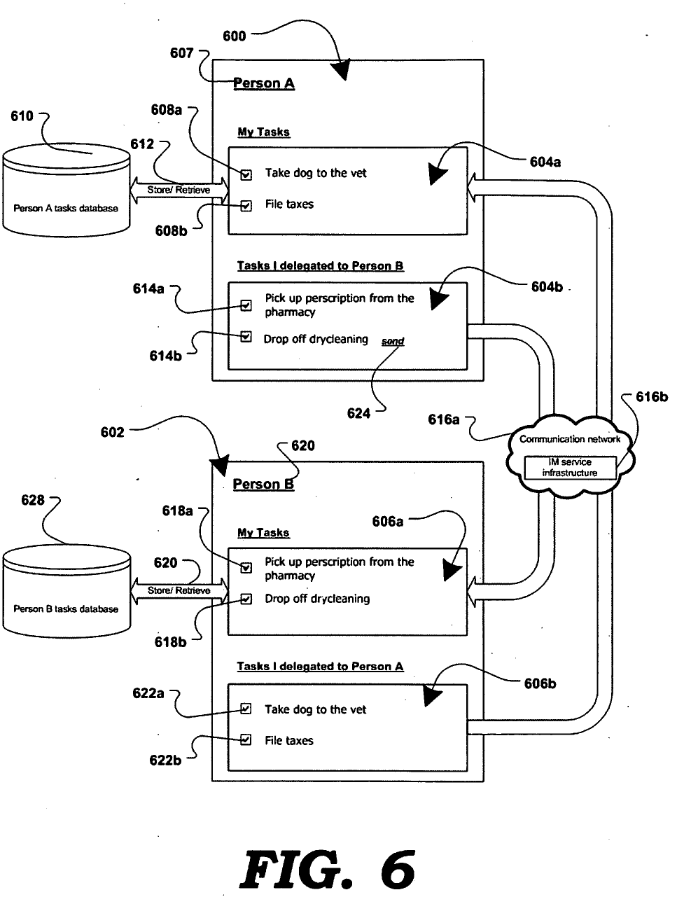

FIG. 6 is a generalized block diagram illustrating the interaction between two tasks modules within an IM framework, according to one embodiment of the present invention. Tasks module 600 and tasks module 620 may be on different client machines, communicating over communications network 616a and IM service infrastructure 616b. Tasks module window 604A may display tasks 608a & 608b assigned to Person A 607 (the user logged into the IM application displaying tasks module 600) by another person or persons such as Person B 620 (the user logged into the IM application displaying tasks module 602 and who is in session with Person A). Person B may use tasks module's 602 delegated tasks window 606b to input and assign tasks to Person A.

The task “Take dog to the vet” 622a may have been created using delegated tasks window 606b, including any properties of the task (such as its due date, urgency, etc.) A synchronization cycle may then take place (immediately after creation of the task or at a later time), uploading the task 622a over an established IM channel 616b, existing as part of a live session, to tasks module 600. Task 622a from Person B, displayed to Person B in the “Tasks I delegated to Person A” window 606b, may then be displayed to Person A in the “My Tasks” window 604a as task 608a. Likewise, tasks 614a & 614b, inputted in by Person A in their “Tasks I delegated to Person B” window 604b, may be uploaded to Person B's task module 602 and displayed in Person B's “My Tasks” window 606a as tasks 618a & 618b. In another embodiment there may be more than one “My Tasks” windows which are displayed at a given time, allowing for tasks to be grouped according to one or more criteria, such as whom has assigned a task, status of the task, when the task is due, priority of the task, etc.

In a preferred embodiment of the present invention, task synchronization may take place as follows: a user creating a task (for example Person A assigning task “Drop off drycleaning” 614b to person B) may indicate their desire to send the task (for example by clicking a button labeled “send” 624). The clicking of the “send” input control 624 may cause a process in tasks module 600 to prepare a task data record containing all pertinent information about task 614b, and send the task data record to the tasks module 602 over the IM live session infrastructure 616a. Upon receipt of the data by the IM application containing tasks module 602, module 602 may parse the incoming task data and display it as task 618b.

In a preferred embodiment of the present invention, tasks data records received by a tasks module (as tasks assigned to the user of that module) may be stored in a tasks database accessible to that module. Upon the initiation of a chat session, a module may read its tasks from storage accessible to it, and upload the tasks to the remote module, in which they may be displayed. Tasks 608a and 608b, assigned to Person A, may be stored 612 in a tasks database 610 accessible to tasks module 600. Tasks 618a and 618b, assigned to Person B, may be stored 620 in a tasks database 628 accessible to tasks module 602. Upon the establishment of a communication session between tasks module 600 and tasks module 602, tasks module 600 may read 612 tasks 608a and 608b from tasks database 610 and send them to tasks module 602, which may be displayed in window 606b. Tasks module 602 may read 620 tasks 618a and 618b from tasks database 628 and send them to tasks module 600, where they may be displayed in window 604b. Tasks database 610 and 628 may be stored on the client device, on an electronic device accessible to the client device, on a local network, on a wide area network, or on a storage device which is accessible (continuously or at discrete moments) to the client device.

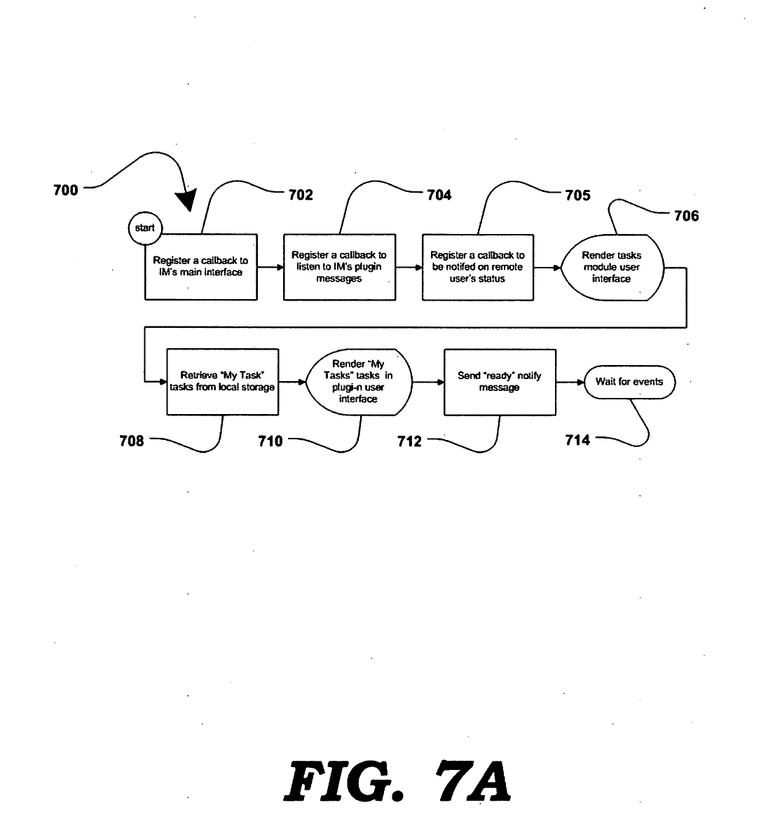

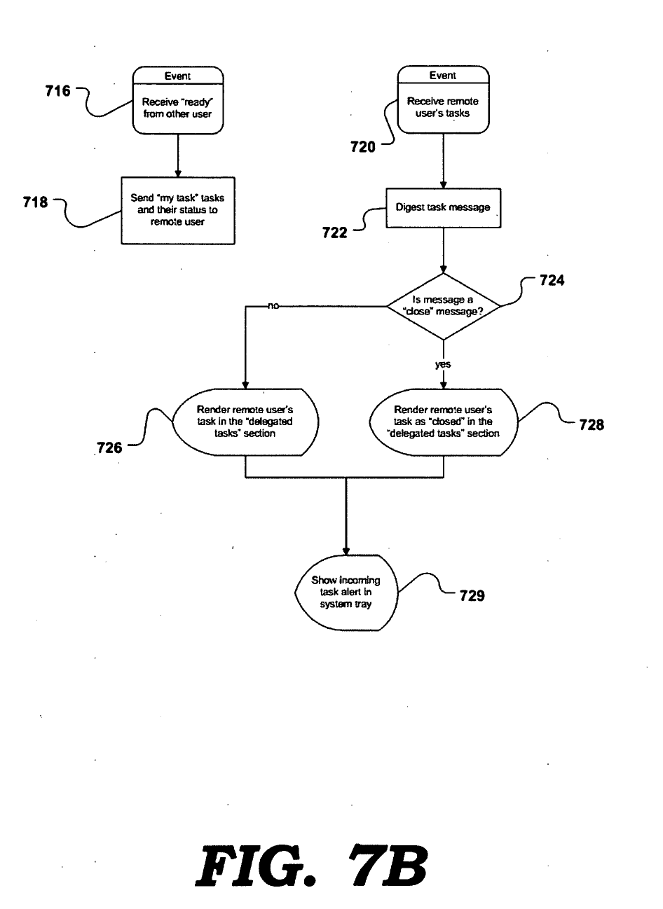

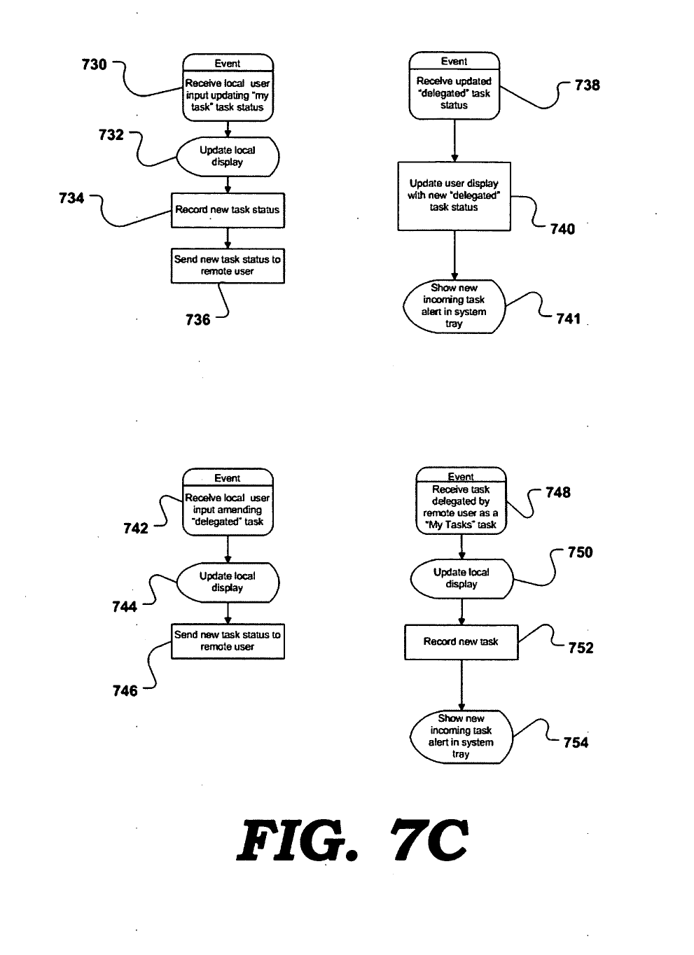

FIGS. 7A and 7B are generalized flow diagrams illustrating the operation 700 of a tasks module in “conversation mode”, according to one embodiment of the present invention. At steps 702-712, an “on Load” function may be called to perform product initialization. An example of one possible implementation of the on Load function:

function onLoad( )

1 function onLoad( )
2 {
3 //register callbacks on main window events
4 host = window.external;
5 //register a callback to listen to plugin messages
6 host.SetEventHandler( ‘PluginMessage’, onPluginMessage );
7 //register to get a message whenremote computer is ready
8 host.SetEventHandler( ‘RemoteReady’, onRemoteReady );
9 //get my list of tasks from local storage
10 RetrieveMyTasks( );
11 //render My Tasks
12 DisplayMyTasks( );
13 //notify ready
14 host.LocalReady ( );
15 }

An example of one possible implementation of the RetrieveMyTasks function:

function RetrieveMyTasks( )

20 //retrieve and display all my tasks from storage
21 function RetrieveMyrasks( )
22 { //loop until all my tasks have been read (loop code not shown)
23 msg=host.StorageRead(TaskID+i);
24 i=i+1;
25 }

At step 702, the tasks module may register itself with the host of the module (line 4), which in the presently preferred embodiment is the IM application. This allows the tasks module to receive messages and communicate with the host IM application. At step 704 the tasks module may register a callback function (line 6) to listen to messages received by the IM application, intended for the tasks module. At step 705 the tasks module may register a callback function (line 8) to be notified of the change in the ready status of the remote tasks module. This may allow, among other things, for the tasks module to upload its tasks to the remote tasks module when a remote tasks module broadcasts its status as “ready”. At step 706 the user interface of the tasks module may be rendered. This may be done in a window adjacent to the main IM application window. Alternatively, the user interface of the tasks module could be separate from the IM application window, or may be hidden or “collapsed”, to be restored upon input from the user or upon the occurrence of one or more criteria. At step 708 tasks may be retrieved from a tasks database (line 10). A loop may be executed calling a command (line 23) to read tasks from the tasks database, iteratively. At step 710 the tasks retrieved may be displayed (line 12) within the “My Tasks” window on the tasks module. At step 712 a “ready” state message me be broadcasted (line 14), so that one or more remote tasks modules will know the local tasks module is online and is ready to accept tasks and tasks synchronization. At step 714 the tasks module may remain active in a waiting state for user input and even notifications.

Referring now to FIG. 7B, the process of event handing is illustrated by generalized flow diagrams. At step 716 an event notification may be received by the associated tasks module informing it that the remote tasks module has sent a “ready” state notification, and is therefore online and ready to receive messages. At step 718 the tasks identified as “my tasks” (that is, tasks designated as intended for the user associated with the host IM), retrieved at step 708, may be sent as data to one or more remote tasks modules. In the example below on RemoteReady( ) at line 21 is the function called by the host IM application upon receipt of a “ready” notification from the remote tasks module.

An example of one possible implementation of the on RemoteReady function:

function onRemoteReady( )

20 //notification received that remote system is ready
21 function onRemoteReady( )
22 {
23 SendSyncTasks( ); //send my tasks and their status to the
remote machine
24 }

An example of one possible implementation of the SendSyncTask function:

function SendSyncTask(ActionOrdinal)

30 function SendSyncTask(ActionOrdinal)
31 {
32 //perform logic to get and set all attributes of the task
33 var Message=new Array( ); //Message holds the new message to be sent
34 Message[ActionOrdinal] = new
35 TaskRecord(FriendsName+ActionOrdinal,ActionVerb,MyName,ActionOrdinal,
36 Subject,DueDate,Importance, “true”);
37 var szMessage=CombineStrings
38 (Message[ActionOrdinal].ID,Message[ActionOrdinal].Status,
38 Message[ActionOrdinal].Owner,
39 Message[ActionOrdinal].Ordinal,
40 Message[ActionOrdinal].Subject,Message[ActionOrdinal].DueDate,
41 Message[ActionOrdinal].Importance,Message[ActionOrdinal].Sync);
42 SendTask(szMessage); //send synced task to friend
43 }

An example of one possible implementation of the TaskRecord function:

function TaskRecord(ID, Status, Owner, Ordinal, Subject, DueDate,
Importance, Sync)

50 //task record definition
51 function TaskRecord(ID, Status, Owner, Ordinal, Subject,
DueDate, Importance, Sync)
52 {
53 this.ID=ID;
54 this.Status=Status;
55 this.Owner=Owner;
56 this.Ordinal=Ordinal;
57 this.Subject=Subject;
58 this.DueDate=DueDate;
59 this.Importance=Importance;
60 this.Sync=Sync;
61 }

An example of one possible implementation of the SendTask function:

function SendTask(szTask)

70 function SendTask(szTask)
71 {
72 host.SendPluginMessage(szTask);
73 }

Function SendSyncTasks(ActionOrdinal) may be called with a parameter representing the ordinal of the task to be sent to a remote tasks module. For example, SendSyncTasks(1) may indicate uploading the first task on the list. Line 34 may create a new message definition, by calling function TaskRecord in line 51, which sets the values of parameters in lines 53-60. In the presently preferred embodiment, once all parameters of a task definition have been defined, function SendTask is called in line 70. At line 72 the method host.SendPluginMessage of the host control may be executed, sending the new task (or tasks) as a massage to one or more remote tasks modules.

At step 720, an event notification may be received by the tasks module notifying the arrival of tasks data from the remote tasks module. For example, function on PluginMessage(msg) in line 81 may be called. The “msg” variable may contain the actual message received. At step 722, a function to digest the message may be called. For example, line 83 may call a function DigestIncomingMessage(msg), passing the message variable “msg” to a function which may examine the message and take different actions depending on the type of message received.

An example of one possible implementation of the on PluginMessage function:

function onPluginMessage(msg )

80 //alert is fired signaling incoming message from the remote user
81 function onPluginMessage(msg )
82 {
83 DigestIncomingMessage(msg);
84 }

An example of one possible implementation of the DigestIncomingMessage function:

function DigestIncomingMessage(msg)

90 //digest received message,
91 //calling proper function based on whether it's a “send” message
or “close” message
92 function DigestIncomingMessage(msg)
93 {
94 //act based on type of message
95 switch (GetStringElement(msg,1))
96 {
97 case “send”:
98 DisplayMessage(msg);
99 break;
100 case “close”:
101 DeleteMessage(msg);
102 break;
103 }
104 }

Function DigestIncomingMessage(msg) at line 92 may examine an segment of the message string—which may determine the type of the message—at line 95, and take action accordingly. At step 724 if the message is determined to be of type “close” (i.e. the task had been marked as completed by the remote user) at step 728 the appropriate task may be marked as completed. Otherwise, at step 726, the task may be rendered. For example, function DisplayMessage(msg) may determine the ordinal task line where the task should be displayed, at line 114. That may be accomplished by extracting an attribute from the message “msg”, passed into the function at line 122. The attribute extracted may indicate the ordinal of the task (e.g. 5^{th} task on the list). At line 117, code (not shown in this example) the task me be rendered. If the message is of type “close”, line 101 may call function DeleteMessage(msg) and the corresponding task may be displayed as completed—for example, crossed out—in line 127.

An example of one possible implementation of the DisplayMessage function:

function DisplayMessage(msg)

| | |
|---|---|
| 110 | //display the incoming message as the proper task |
| 111 | function DisplayMessage(msg) |
| 112 | { |

| | |
|---|---|
| 113 | //figure out line number task belongs to |
| 114 | switch (GetStnngElement(msg,3)) |
| 115 | { |
| 116 | //[code omitted]perform GUI on that line number, |
| | showing the new task, etc. |
| 117 | } |

| | |
|---|---|
| 118 | } |

An example of one possible implementation of the DeleteMessage function:

function DeleteMessage(msg)

```
120  //incoming message is meant to delete a task so show task as
        deleted
121  //then synchronize message back so gets deleted on sender's
        machine
122  function DeleteMessage(msg)
123  {
124  //figure out line number task belongs to
125  switch (GetStringElement(msg,3))
126  {
127  //[code omitted] perform GUI to show task as deleted
128  }
129  }
```

In a preferred embodiment the user of the tasks module receiving the message, may be displayed an alert 729 (e.g. in the system tray of their operating system) informing of the receipt of an updated task.

Referring now to FIG. 7C, the process of event handing is illustrated by generalized flow diagrams. At step 730 input may be received from the local user updating the status of one of their tasks. (For example, marking one of the tasks in the “my tasks” section as “complete”) At step 732 the local tasks module display may be updated to reflect the user input updating the status of a task. At step 734 the new task status may be recorded to a tasks database. At step 736 the new task status may be sent to one or more remote tasks modules for display to the remote user(s).

At step 738 data may be received from the remote tasks module updating the status of one or more of the tasks delegated to the remote user. For example, the user of the remote tasks module may have marked a task assigned to them as “complete”. At step 740 the local tasks module may update its display with the updated task received, under the “delegated tasks” section. In another preferred embodiment the user of the tasks module receiving the message, may be displayed an alert 741 (e.g. in the system tray of their operating system) informing of the receipt of an updated task.

At step 742 input may be received from the user of the local tasks module amending a task that had been delegated. For example, the local user may cancel a task they had delegated to the remote user. At step 744 the local tasks module display may be updated to reflect the user's amendment of the delegated task. For example, the text of the task cancelled may appear with a red line through it. At step 746 the amended task may be sent to the remote tasks module for display to the remote user.

At step 748 task data, containing a task delegated by the remote user, may be received by the local tasks module. For example, the task data may include a new task and its properties, such as priority and due date; or, the task data may be an amendment to an existing task. At step 750 the display of the local tasks module may be updated to include the new task. For example, under “my tasks” in the local tasks module, the new task may appear. If the task data received at step 748 indicates a status change for an existing task, such as the remote user's canceling of a previously-delegated task, the task cancelled by the remote user may be crossed out with a red line. At step 752 the redefined task received at step 748, may be stored in a task database. In another preferred embodiment the user of the tasks module receiving the message, may be displayed a task alert 754 (e.g. in the system tray of their operating system) informing of the receipt of an incoming task (i.e. a new task alert).

For example, function RecordTask in line 130 may be called and may receive a variable “msg” containing the task definition and other properties of the task. In line 133 task properties, such as the unique name the task should be stored under, may be extracted and a method exposed by the host of the tasks module, such as host.StoragWrite( ), may be invoked to record the task.

An example of one possible implementation of the RecordTask function:

function RecordTask(msg)

130 function RecordTask(msg)
131 {
132 //write to storage using ID based on friend's name and
task line # as ID
133 host.StorageWrite(GetStringElement(msg,0),msg);
134 }

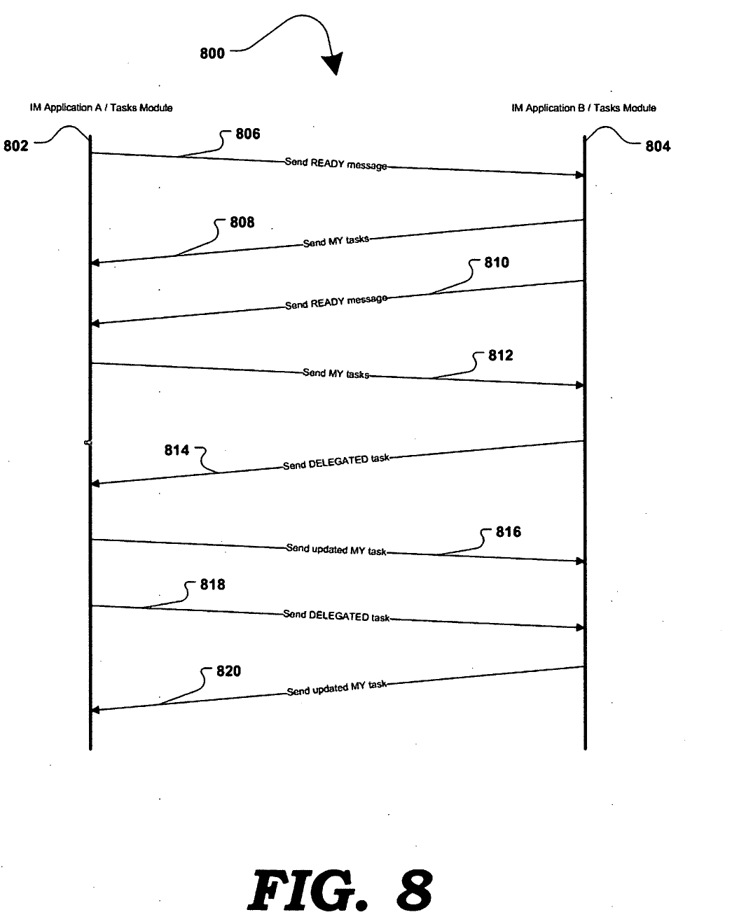

FIG. 8 illustrates a communication flow between two tasks modules in one embodiment of the present invention. System 800 represents a model where two tasks-modules 802 and 804 are able to communicate with each other in a live session. while not required, the presently preferred embodiment utilizes the IM infrastructure to relay messages and information between two task modules. For example, System 800 may represent two IM applications, enabled with tasks modules, communicating over an IP network as part of a live chat session between the user of IM application A and the user of IM application B. Tasks module 802 may send a “READY” message 806 to tasks module 804, signaling to tasks module 804 that it is online and is ready to communicate. In response to ready message 806 received by tasks module 804, tasks module 804 may send “MY” tasks 808 to tasks module 802. “MY” tasks 808 may consist of one or more tasks originally delegated by the user of tasks module 802 to the user of tasks module 804. The “MY” tasks may be sent as a single message, or in a series of messages. The tasks 808 may have been modified by the user of tasks module 804 while offline (i.e. not in a live session with the user of tasks module 802) and the modifications may have been saved by tasks module 804, prior to being sent 808 to tasks module 802. Tasks module 804 may send a “READY” message 810 to tasks module 802, signaling to tasks module 802 that it is online and is ready to communicate. In response to ready message 810 received by tasks module 802, tasks module 802 may send “MY” tasks 812 to tasks module 804. Tasks module 804 may then display tasks 812, which the user of tasks module 804 may have originally delegated to the user of tasks module 802.

The user of tasks module 804 may create and delegate a task to the user of tasks module 802. To do so tasks module 804 may send “DELEGATED” task 814 to tasks module 802. Upon receiving delegated task 814, tasks module 802 may display the task to the user of tasks module 802, and/or may store it. The user of tasks module 802 may choose to modify a task delegated to them (for example, flag a task in “my tasks” as “done” upon completing it) and then send the updated task 816 to tasks module 804. Similarly, the user of tasks module 802 may create and delegate a task to the user of tasks module 804. To do so tasks module may send “DELEGATED” task 818 to tasks module 804. Upon receiving delegated task 818, tasks module 804 may display the task to the user of tasks module 804, and/or may store it. The user of tasks module 804 may choose to modify a task delegated to them (for example, flag a task in “my tasks” as “done” upon completing it) and then send the updated task 820 to tasks module 802.

In alternate embodiments of the present invention, other messages may be exchanged, the sequence of the messages may be different and more than two tasks modules may be involved in exchanging on ore more tasks.

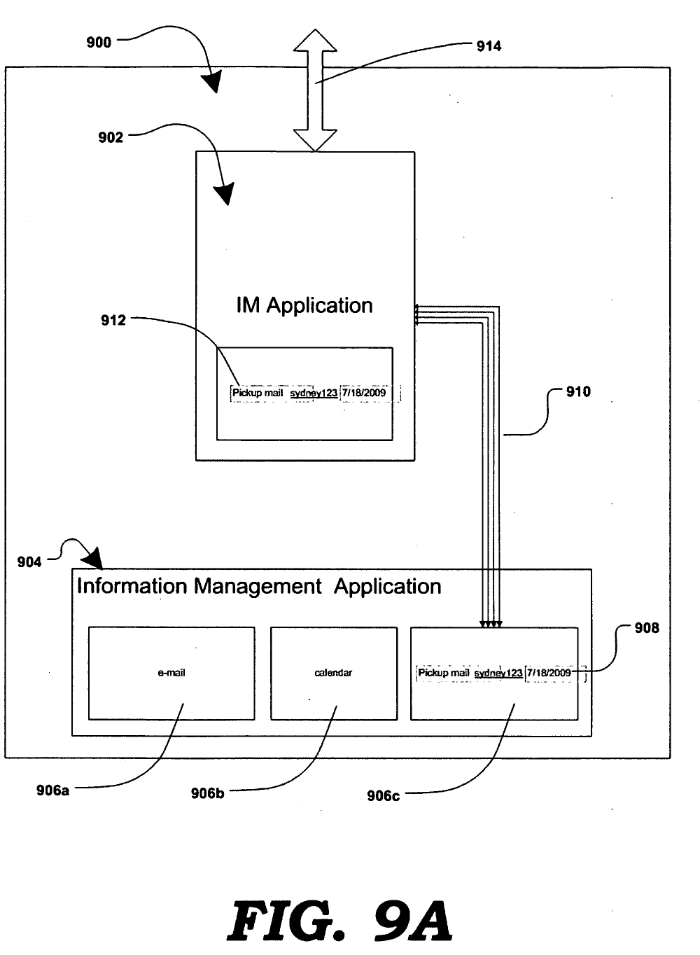

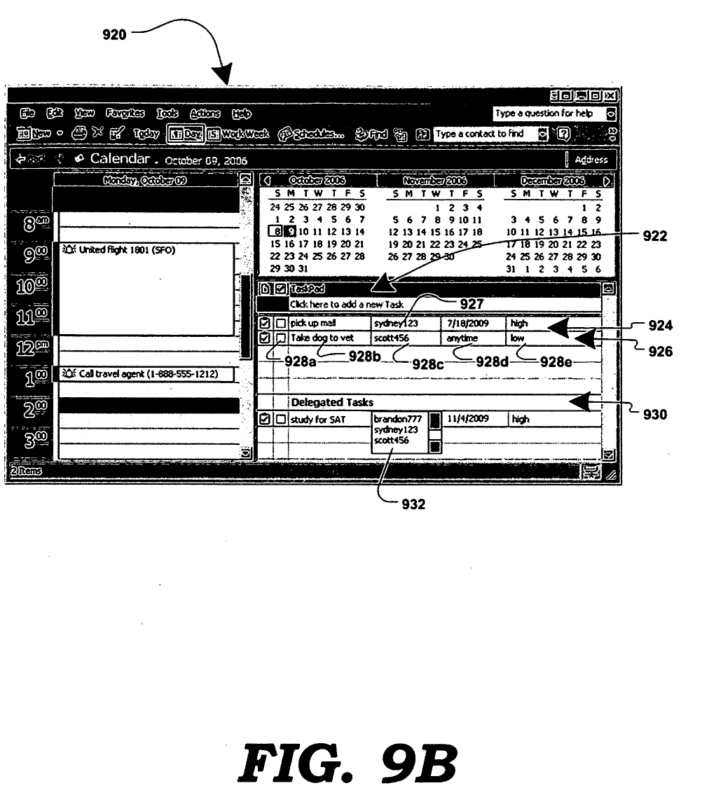

FIGS. 9A and 9B are a generalized block diagrams illustrating the utilization of an IM application and infrastructure to facilitate an exchange of tasks among information management applications, according to one embodiment of the present invention. An IM application 902 and an information management application 904 (e.g. Microsoft Outlook®, Lotus Notes®, Palm® and Blackberry® management applications) may run on client machine 900. Information management application 904 may be commercial software such as Microsoft Outlook®, Lotus Notes®, handheld-device interface software, or any application which allows a user to track tasks. Information management application 904 may include functionality to interface with e-mail 906a, a calendar 906b, a tasks manager/to-do-list 906c, and other functionality and tools.

Tasks 908 created, displayed, edited and tracked in information management application 904, may be linked 910 to tasks 912 in an IM application. Tasks received by IM application 902 may be shared 910 with information management application 904. Sharing process 910 may be facilitated via a data exchange mechanism, such as OLE/DDE; or, by IM application 902 being able to write to information management application's 904 data store; or, by information management application's 904 being able to read IM application's 902 data store. For example, IM application 902 may receive a task 912 “pickup mail” from user “sydney123”, due on “Jul. 18, 2009”. Task 912 may be shared with information management application 908. In an example where information management application 908 is Microsoft Outlook®, the user of Outlook® will open up the “tasks” view and see task 912 as a task 908 in Outlook®. The user may edit (or mark as complete) task 908 in Outlook®, or in a PDA/cell-phone synchronized with Outlook®. The edited task 908 may then be synchronized back with IM application 902, as task 912, and may then be sent by IM application 902 to remote IM users via an IP communication channel 914, which is part of an IM communication infrastructure.

In an alternate embodiment of the present invention, information management application 904 may utilize components of IM application 902 (e.g. COM objects, ActiveX controls, plug-ins, OLE/DDE, DLLS, etc) to facilitate communication over the IM infrastructure 914, without the need for a user to actively use IM and/or without the IM application needing to be displayed.

In an alternate embodiment of the present invention, IM application 902 may be an integral part of information management application 904. Information management application 904 may have IM functionality built-in, as part of its own code-base.

In another embodiment of the present invention, either the information management application 904, or the IM application 902, or both, may be wholly or partly network-based.

Referring now to FIG. 9B, an integration between the tasks module of an IM application and an information management application, according to one embodiment of the present invention, is illustrated. An information management application 920 (e.g. Microsoft Outlook®. Lotus Notes®, Palm® and Blackberry® management applications) may display a tasks window 922. Tasks window 922 may display tasks 924 and 926, assigned to the user of the information management application by remote users 927 and 228c, respectively. Tasks 924 and 926 may be received by a tasks-enabled IM application and shared electronically with information management application 920. In an alternate embodiment, tasks-enabled components of an IM application may be embedded in, or used by, information management application 920 to facilitate an exchange of tasks with remote users, such as “sydney123” 927 and “scott456” 298c. A task 926 received over an IM communications network, may be displayed in the tasks window 922 of an information management application 920 along with attributes of the task, including the task's completion flag 928 (e.g. checked if task is complete), task message 928b, the task sender's name 928c, the task's due date 928d, the task's priority 928e. Other relevant task attributes may be displayed in other embodiments.

In an alternate embodiment of the present invention, the user of information management application 922 may be able to sort tasks 924 & 926 in various orders (e.g. by priority), filter the tasks displayed based on criteria (e.g. sender's name or task priority or due date), and mark tasks as complete or change their completion status (e.g. by checking a completion checkbox 928a.)

In an alternate embodiment of the present invention, information management application 920 may contain an interface 930 for allowing the user to create and assign tasks to remote users. A list 932 of all IM users capable of receiving tasks from the local user, may be displayed.

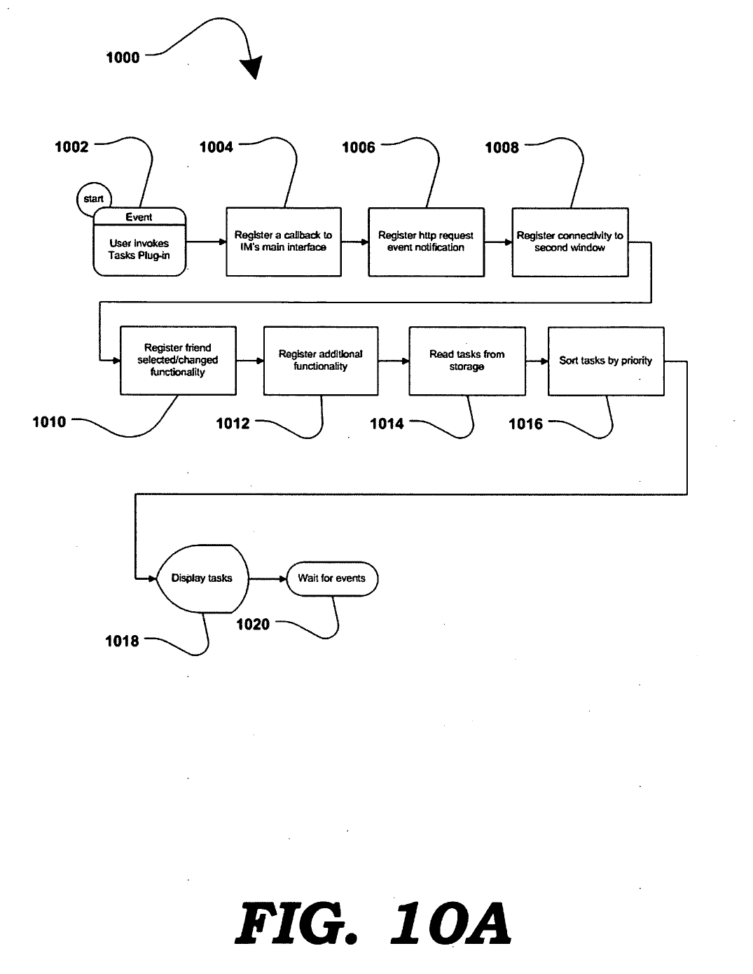

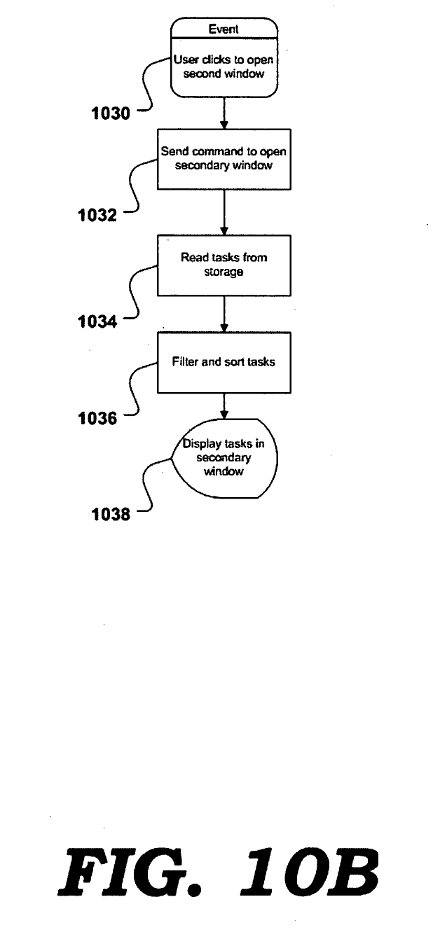

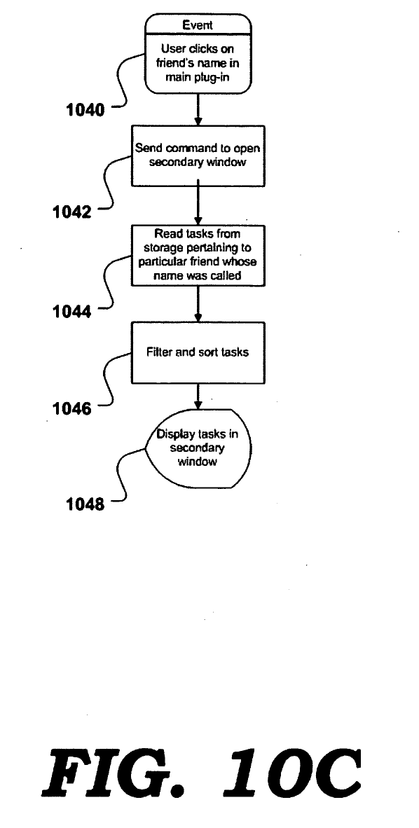

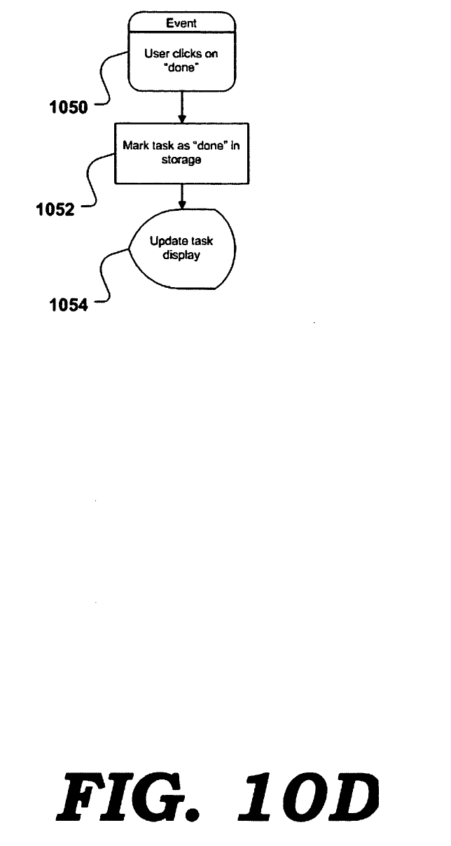

FIGS. 10A/10B/10C/10D are generalized flow diagrams illustrating the operation 1000 of a tasks module in a “Content Tab mode”, according to one embodiment of the present invention. Content Tab mode refers to the operation of a tasks module outside of a live session. I.e. the tasks module is presented as content to the user, allowing the user to view and modify tasks while not online or not connected to a session with a remote user. At step 1002 an event may be received by the host IM application, indicating the user has chosen to activate the tasks module tab. (e.g. the user may choose the tasks plug-in from a list of plug-ins, such as music, news, etc.) At step 1004 a callback to the host IM may be registered by the tasks module. At step 1006 http request registration may be performed.

At step 1008 connectivity to a second window may be registered. A second window may be created by the tasks module to allow for more information to be displayed. For example, the main tasks module may contain summarized information about tasks, whereas a second window may contain task information in greater detail. At step 1010 a callback function for event notification upon the changing or selection of a “friend”, may be registered. For example, when the user clicks on the name of a different friend in the IM application's friends list, a notification may be received by the local tasks module that a new friend's name has been selected. In one embodiment of the present invention, this may cause the tasks module to load the tasks assigned to, and by, the new friend selected in the friends' list. At step 1012, additional callback functionality may be registered for any additional events that may be useful to enhance the functionality of the local the tasks module. At step 1014, tasks may be read from a storage device accessible to the tasks module. At step 1016 tasks read at step 1014 may be sorted. For example, out of consideration for limited display space in a tasks module which is part of an IM application, tasks may be sorted such that only those of the highest priority may be shown. At step 1018 the tasks retrieved at step 1014 and sorted at step 1016, may be displayed.

At step 1030, a click event by the user is received, indicating the user has chosen to launch a secondary tasks module window. At step 1032 a command is sent to create the secondary window. At step 1034 tasks may be read from storage. At step 1036 tasks may be filtered based on various criteria, and at step 1038 the tasks may be displayed in the second window of the tasks module. For example, the secondary window may be launched and the task records retrieved from the database may be filtered to include only those tasks that are of the highest priority. A user preference setting may allow the user to choose a criteria for filtering and sorting tasks in the secondary window of the tasks module.

At step 1040, a click event by the user is received, indicating the user has chosen to launch a secondary the tasks module window by clicking on a task associated with a certain user. At step 1042 a command is sent to create the secondary window. At step 1044 tasks may be read from storage. At step 1046 tasks may be filtered based on the name of the user associated with a task, and at step 1048 the tasks may be displayed in the second window of the tasks module. For example, a user may click on a task in the main the tasks module window. The secondary window may be launched and the task records retrieved from the database may be filtered to include only those records pertaining to the user whose name was on the task clicked in the original window.

At step 1050, a click event by the user may be received indicating the user has chosen to mark a certain task as “done”. At step 1052, the record of the specific task may be update to denote the new status of the task. For example, one or more elements of the task record may indicate the state of the task. In one embodiment, a binary value could be used so an element set to “true” means the task is active, while “false” means the task is complete. At step 1054, the visual presentation of the task may be altered, to reflect the change in the task status to “done”. For example, a red line may be used to cross out the task. At a later time, a synchronization cycle may take place, uploading the new status of the task to a remote the tasks module.

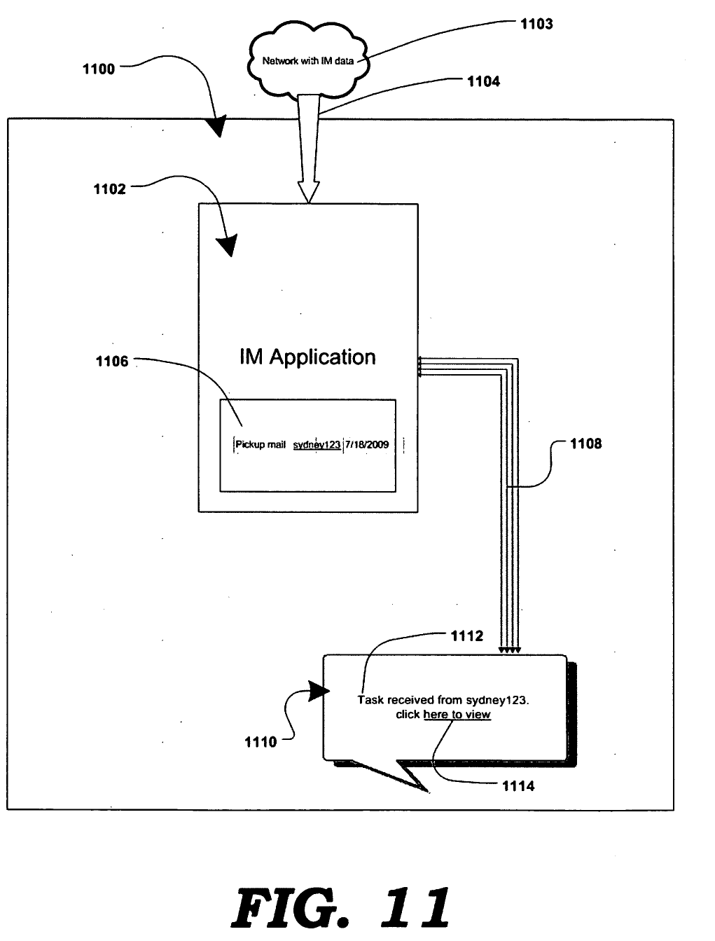

FIG. 11 is a generalized block diagram illustrating displaying a user alert in response to a received task, in one embodiment of the present invention. IM application 1102 may run on client machine 1100 and may receive tasks 1104 from remote IM applications over communications network 1103. Upon receiving a task 1106, IM application 1102 may produce an alert on a display device accessible to client machine 1100. In a currently preferred embodiment, the alert message may be presented to the user as a “toaster” alert 1110 (i.e. an alert window that pops up, usually in the system-tray, or bottom-right corner of the screen). Alert 1110 may contain a message 1112, such as information about the alert received. For example, “Task received from sydney123. Click here to view”. The message 1112 may contain a hyperlink 1114, allowing the user to click the hyperlink 1114 and open up IM application 1102, displaying task 1106.

Alternate embodiments of the present invention may allow the user to select whether or not to be notified by an alert 1110 upon the receipt of a task. The user may choose the type of tasks to be notified on. For example, the user may choose to be alerted only on tasks from certain user(s); only on tasks with a specified priority level, the name or subject mater of the task, the due date of the task, etc. The user may also choose the properties of the alert 1110, such as its size, position, skin, content, sounds to be played when the alert appears, etc.

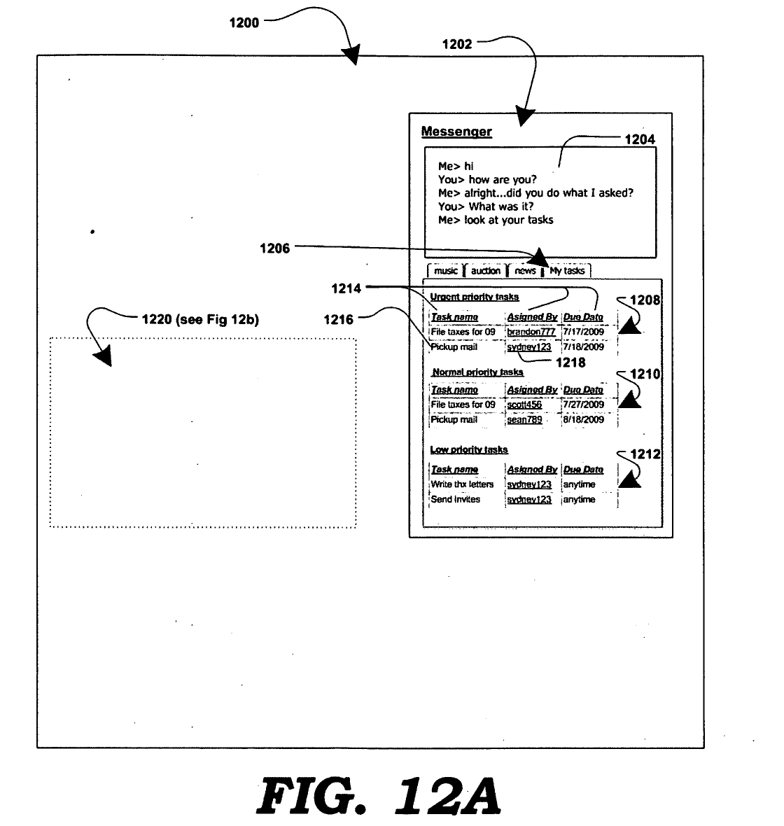

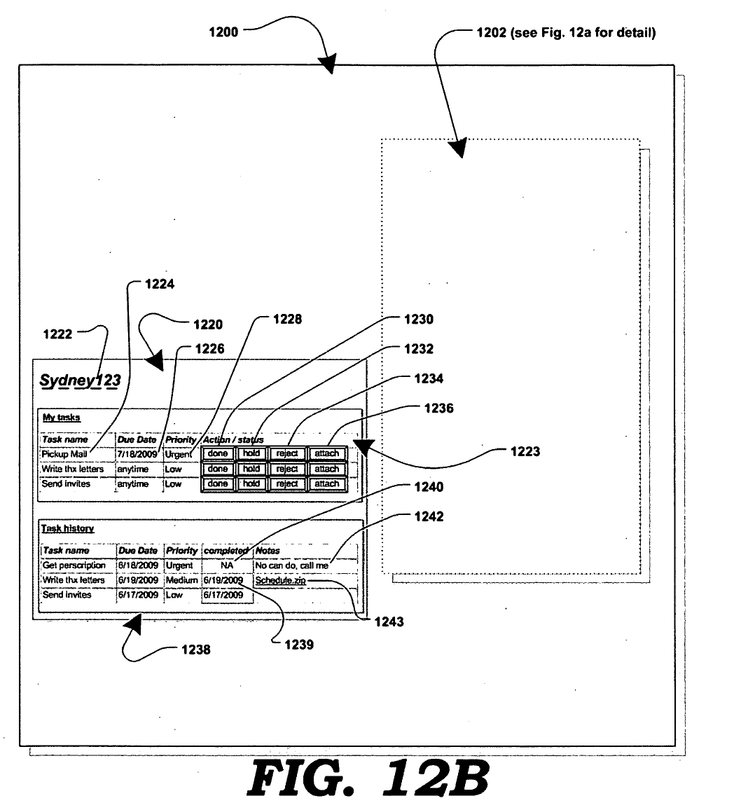

FIGS. 12A and 12B are generalized block diagrams illustrating the interaction between a tasks module, a second tasks-module-window, and a host IM application, according to one embodiment of the present invention. Referring to FIG. 12A, an IM application 1202 may run on a client machine 1200. Generally, IM application 1202 may contain a chat window 1204, which may show a text chat between the user of IM application 1202 and one or more remote users. IM application 1202 may support one or more modules—typically in the form of plug-ins—to enhance its functionality. (e.g. modules to search for and play music, view online auctions, read news, etc.). One of the modules may be related to the assignment and tracking of tasks 1206. Tasks module 1206 may contain a list of tasks assigned to the user of IM application 1202, in various embodiments. In one embodiment, the list of tasks may be divided into three groups: “urgent priority tasks” 1208, “normal priority tasks” 1210 and “low priority tasks” 1212. Tasks displayed in tasks module 1206 may be delimited by attributes 1214, such as “task name”, “assigned by”, and “due date”. A task 1216 may display a title/body, such as “pickup mail”, the name of the sender, such as “sydney123” 1218 and a due date. The name of the person assigning the task, such as “sydney123” 1218 may be hyperlinked, allowing the user to click on it and open a secondary window 1220. In a preferred embodiment the tasks displayed in secondary window 1220 may be in context of the user 1218.

Referring now to FIG. 12B, the secondary tasks window 1220 may open in context of the user 1218 associated with a task in tasks module 1206. The name of the user 1222 may be displayed in the secondary tasks window 1220 to denote that all tasks in the secondary window 1220 are tasks related to user “sydney123” 1222. Secondary tasks window 1220 may be divided into various views, such as a “my tasks” frame 1223 and a “task history” frame 1238. “Task history” frame 1238 may contain a listing of one or more tasks that are inactive, and their status. (e.g. tasks that had been completed or were rejected, etc.) In other embodiments of the present invention, more information frames may be shown, such as a frame listing tasks that had been delegated to the remote user “sydney123”.

A task may be listed with various attributes: the task name (or “body” or “title”) 1224, the task's due date (may be expressed as a date, or word such as “ASAP”, etc.) 1226, the task's priority (may be a number such as 1-10, or a word such as “urgent”, etc.) 1228, and any other attributes. Tasks may be sort-able in multiple ways, such as by due-date, by priority, in ascending or descending alphabetical order, etc.

The user of tasks window 1220 may be presented with a list of actions they may be able to invoke with respect to a given task. Task “Pickup Mail” 1224 may have an associated set of actions, such as “done” 1230, “hold” 1232, “reject” 1234 and “attach” 1236. In other embodiments, a greater set of actions may be made available to the user. Action button “done” 1230 may be used by the user to signify that task 1224 has been completed. A “done” action may alter a task's record to include a flag to signify the task's completion and may include a date/time stamp 1239 of the date and time when the task was completed. A “hold” action may alter the task's record to signify the user may not be able to perform the task in the allotted time. The user may be able to append a comment 1242 to the task's record to further explain their reasoning. A “reject” action may alter the task's record to signify the user has rejected. The user may be able to append a comment 1242 to the task's record to further explain their reasoning. An “attach” action 1236 may alter the task's record by incorporating a file attachment 1243, or a reference to a file. The user may be able to append a comment 1242 to the task's record to describe the attachment 1243. Tasks may also be grouped or arranged, for example by having sub-tasks associated with a given task. Each subtask may have its own action button and in one alternative embodiment the higher level task may not be marked as completed until all the associated sub-tasks are marked as completed.

The new status of a task—or any changes to its record—may be sent to the remote user immediately, or at any point thereafter.

The examples above demonstrate the power and flexibility of the present invention in providing a means for enhancing instant messenger services by adding and incorporating a framework for a peer-to-peer exchange of tasks among instant messenger users.

The invention has been described with reference to particular embodiments. However, it will be readily apparent to those skilled in the art that it is possible to embody the invention in specific forms other than those of the preferred embodiments described above. This may be done without departing from the spirit of the invention.

Thus, the preferred embodiment is merely illustrative and should not be considered restrictive in any way. The scope of the invention is given by the appended claims, rather than the preceding description, and all variations and equivalents which fall within the range of the claims are intended to be embraced therein.

What is claimed is:

1. A method of managing tasks in a computer system, comprising:
receiving a task message from an IM communications network; and
displaying an indication of the received message in a task module associated with an IM client.

2. The method of claim 1, further comprising displaying a task alert, wherein the task alert is displayed separately from the task module.

3. The method of claim 1, in a task module associated with an IM client, further comprising:
displaying a task message; and
displaying a task status indication.

4. The method of claim 3, further comprising:
presenting a task status control; and
in response to user selection of the task status control, changing the status of a task.

5. The method of claim 4, further comprising:
in response to a change in the status of a task, sending a task message indicating the change in task status to a recipient associated with the task message, wherein the task message indicating the change in task status is sent using the IM communications network.

6. The method of claim 5, wherein the recipient associated with the task message is the originator of the task message from the IM communications network.

7. The method of claim 1, wherein the task module is a plug-in.

8. The method of claim 1, wherein the task module is a component of a desktop productivity program.

9. The method of claim 3, wherein the displayed task messages correspond to tasks received from at least one other user.

10. The method of claim 9, further comprising:
displaying a user indicator associated with the displayed task message.

11. The method of claim 10, wherein the displayed user indicator associated with the displayed task message corresponds to the user who sent the task.

12. The method of claim 10, wherein the displayed user indicator associated with the displayed task message corresponds to the user to whom the task is delegated.

13. The method of claim 3, further comprising:
displaying a delegated task message; and
displaying a delegated task status indication.

14. The method of claim 13, wherein the delegated tasks are displayed in a delegated task window.

15. The method of claim 1, wherein the task message is received from a task repository of the IM communications network, wherein the task repository stores task messages until the task module associated with the IM client appears on the IM communications network.

16. A method of managing tasks in a computer system comprising:
presenting a task creation area in a task module associated with an IM client;
presenting a send task control in said task module; and
in response to receiving a send task indication from a user operating said send task control, transmitting a task message including a task created in the task creation area to an IM communications network.

17. The method of claim 16, further comprising:
presenting a task recipient area in the task module;
associating a task recipient with the task message; and
transmitting the associated task recipient with task message.

18. The method of claim 16, wherein the task message is transmitted directly from the task module to the IM communications network.

19. The method of claim 16, wherein the task message is transmitted to the IM communications network through the associated IM client.

20. The method of claim 16, further comprising:
receiving a task message from an IM communications network; and
displaying an indication of the received message in the task module.

21. The method of claim 20, further comprising:
presenting a task status control;
in response to user selection of the task status control, changing the status of a task; and
in response to a change in the status of a task, sending a task message indicating the change in task status to at least one recipient associated with the task message, wherein the task message indicating the change in task status is sent using the IM communications network.

22. A task module, comprising:
an interface for communicating with an IM network;
a task display area, wherein revived task information is sent to the task display area to provide a visual indication of the received task information; and
a task manager for receiving task information from an IM network, the task manager providing received task information to the task display area and sending task information through the IM network interface;

23. The task module of claim 22, wherein the task display area includes tasks to be assigned to other parties, and wherein the task manager sends task information on a task assigned to another party in response to a received command from a user of the task module.

24. The task module of claim 22, wherein the interface for communicating with an IM network is an interface to an IM client.

25. The task module of claim 22, further comprising:
a task creation area.

26. The task module of claim 25, further comprising:
a send task control, wherein a task message including a task created in the task creation area is transmitted to at least one designated recipient through the IM interface.

27. The task module of claim 22, further comprising:
a task status control; wherein in response to user selection of the task status control, the task manager changing the status of a task.

28. The task module of claim 27, wherein in response to a change in the status of a task, the task manager sends a task message indicating the change in task status to a recipient associated with the task message, wherein the task message indicating the change in task status is sent using the IM interface.

29. The task module of claim 26, wherein the task manager holds a task which has been designated for sending in a send task cache in the event the IM interface indicates the task module is not in communication with an IM communications network.

30. A method of managing tasks in a computer system using an IM communications network, comprising:
receiving a task message from a task module through an IM client;
determining the intended recipient of the task message; and
transmitting the task message to a task module associated with the intended recipient through an IM client, wherein the intended recipient is associated with an IM address on said IM network.

31. The method of claim 30, further comprising:
in the event the task module associated with the IM network is not on line, holding the task message until the task module associated with the intended recipient appears on line.

32. The method of claim 30, wherein the task message includes:
a task;
a task sender;
a task status;
a task priority;
a due date, and
a delegated user.

33. The method of claim 30, wherein the task message further includes a task identifier.

34. The method of claim 30, wherein the task message includes:
a task identifier; and
a task status change indicator.

35. The method of claim 30, wherein the task manager broadcasts a task synchronization message after connecting to an IM communications network.
